(19) United States
(12) Patent Application Publication
(10) Pub. No.: US 2016/0026364 A1
(43) Pub. Date: Jan. 28, 2016

(54) HUB-BASED BENEFITS SYSTEM AND METHOD

(71) Applicant: ADP, LLC, Roseland, NJ (US)

(72) Inventors: Benjamin J. Dziuba, New York, NY (US); Jesse S. Zolna, Larchmont, NY (US)

(21) Appl. No.: 14/497,422

(22) Filed: Sep. 26, 2014

Related U.S. Application Data
(60) Provisional application No. 62/028,500, filed on Jul. 24, 2014.

(51) Int. Cl. G06F 3/0481; G06F 3/0484; G06Q 10/10

(52) U.S. Cl. CPC G06F 3/04817; G06Q 10/1057; G06F 3/04842

(57) ABSTRACT

A hub-based user interface (UI) is provided for obtaining and presenting employee benefits information. The hub-based UI may present the user with a comprehensive view of the state of the benefits based on inputs provided by the user. A method of generating an employee benefit UI includes determining, by a computer system, one or more benefits based on a combination of user input and a predefined set of benefits. The method also includes generating, by the computer system, a reconfigurable, dynamic hub UI that includes a listing of the one or more benefits, wherein each of the one or more benefits in the listing includes a respective selectable object. The method additionally includes navigating to a benefit UI associated with a particular one of the one or more benefits based on receiving a selection of the selectable object associated with the particular one of the benefits.

### TECHNICAL FIELD

The invention relates to user interfaces and, more particularly, to a method and system for providing a user interface adapted for obtaining and displaying employee benefit information.

### BACKGROUND

A software wizard (also called a setup assistant) is a type of user interface that presents a user with a sequence of dialog boxes (or screens) that lead the user through a series of well-defined steps. Wizard interfaces are routinely programmed such that a user is constrained to step linearly through the sequence of dialog boxes/screens, i.e., in a predefined order without deviating from the order. Further, wizards do not provide adequate feedback to users in that they do not show a user what application state gets changed as user choices are made.

### SUMMARY OF INVENTION

In accordance with a first aspect of the invention, there is a method of generating an employee benefit user interface (UI). The method includes determining, by a computer system, one or more benefits based on a combination of user input and a predefined set of benefits. The method also includes generating, by the computer system, a reconfigurable, dynamic hub UI that includes a listing of the one or more benefits, wherein each of the one or more benefits in the listing includes a respective selectable object. The method additionally includes navigating to a benefit UI associated with a particular one of the one or more benefits based on receiving a selection of the selectable object associated with the particular one of the benefits.

In accordance with another aspect of the invention, there is a computer system for generating an employee benefit user interface (UI). The computer system includes a hardware memory device that stores program instructions. The computer system also includes a hardware processor that executes the program instructions and causes the computer system to: generate a hub UI that includes a listing of one or more benefits based on a combination of user input and a predefined set of benefits; navigate to a benefit UI associated with a particular one of the one or more benefits based on receiving a selection of the particular one of the benefits at the hub UI; receive an election of the particular one of the benefits at the benefit UI; and, based on the receiving the election, reconfigure the hub UI to visually indicate the election of the particular one of the benefits.

In accordance with another aspect of the invention, there is a computer program product comprising computer readable program instructions stored on computer readable storage medium. The computer readable program instructions cause a computing device to: generate a hub UI that includes a listing of one or more benefits based on a combination of user input and a predefined set of benefits; navigate to a benefit UI associated with a particular one of the one or more benefits based on receiving a selection of the particular one of the benefits at the hub UI; receive an election of the particular one of the benefits at the benefit UI; based on the receiving the election, reconfigure the hub UI to visually indicate the election of the particular one of the benefits; generate a review UI using information defined by user inputs associated with elections of each of the one or more benefits; and navigate to the review UI based on completing the elections of each of the one or more benefits.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is an illustrative architecture of a computing system implemented as embodiments of the present invention;

FIG. 2 shows an exemplary cloud computing environment in accordance with aspects of the invention;

FIG. 3 shows a block diagram in accordance with aspects of the invention; and

FIGS. 4-14 show user interfaces that illustrate functionality in accordance with aspects of the invention.

### DETAILED DESCRIPTION OF ASPECTS OF THE INVENTION

The invention relates to user interfaces and related functionality and, more particularly, to systems and methods to obtain and display employee benefit information. In accordance with aspects of the invention, a hub-based user interface is provided for obtaining and presenting employee benefits information. The employee benefits may be related to, for example and without limitation: medical insurance, vision insurance, dental insurance, life insurance, accidental death and dismemberment insurance, disability insurance, spousal insurance, dependent care, commuter benefit, educational assistance, retirement benefits, etc. In embodiments, the hub-based user interface presents the user with a comprehensive view of the state of the benefits based on data provided by the user. In embodiments, the hub-based user interface permits a user to navigate non-linearly through a number of benefit selection screens, i.e., without being constrained to a predefined order of the data entry screens. In embodiments, the systems and methods also function to show changes in the state of the benefits as the user makes benefit selections, i.e., show real time changes to the comprehensive view of the state of the benefits as a result of benefits selections by the user. In this manner, implementations of the invention provide methods and systems for providing a user interface that assists a user in selecting their desired benefits configuration.

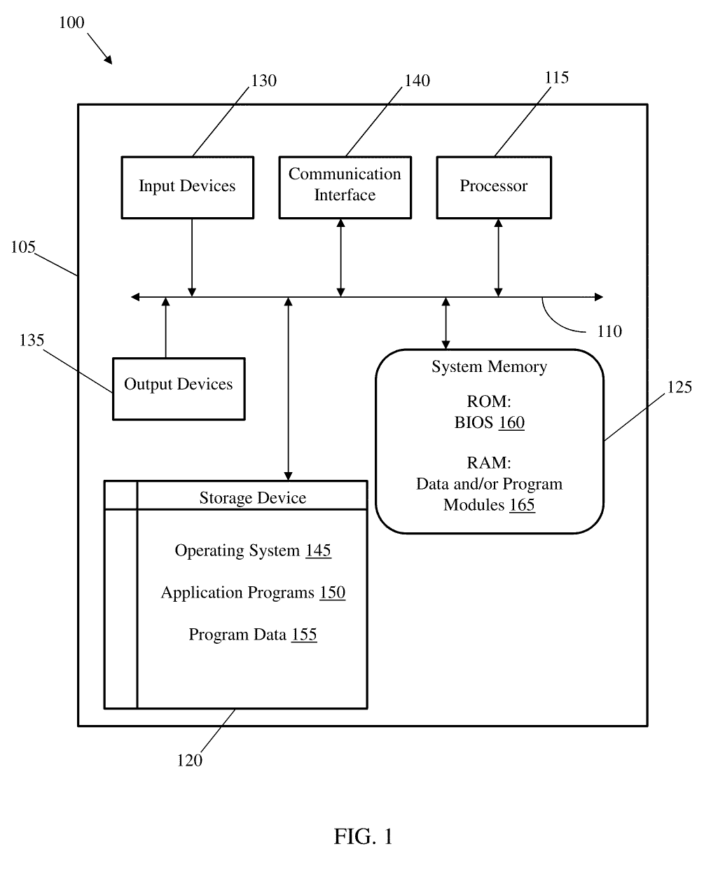

FIG. 1 is an illustrative architecture of a computing system 100 implemented as embodiments of the present invention. The computing system 100 is only one example of a suitable computing system and is not intended to suggest any limitation as to the scope of use or functionality of the invention. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment, or may be a separate independent computing device (e.g., a computing device of a third party service provider). The computing device 105 may include a bus 110, a processor 115, a storage device 120, a system memory 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more conventional processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present invention, which may be operatively implemented by the computer readable program instructions. In embodiments, processor 115 may receive input signals from one or more input devices 130 and/or drive output signals through one or more output devices 135. The input devices 130 may be, for example, a keyboard or touch sensitive user interface (UI) as further described below. The output devices 135 can be, for example, any display device, printer, etc., as further described below.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present invention In embodiments, storage device 120 may store operating system 145, application programs 150, and program data 155 in accordance with aspects of the present invention.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, and combinations thereof. The one or more output devices 135 may include one or more mechanisms that output information to an operator, such as, but not limited to, audio speakers, headphones, audio line-outs, visual displays, antennas, infrared ports, tactile feedback, printers, or combinations thereof.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to generate and present a user interface and related functionality as described herein. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In some embodiments, an operator may interact with computing device 105 via the one or more input devices 130 and/or the one or more output devices 135 to facilitate performance of the tasks and/or realize the end results of such tasks in accordance with aspects of the present invention. In additional or alternative embodiments, hardwired circuitry may be used in place of or in combination with the program instructions to implement the tasks, e.g., steps, methods and/or functionality, consistent with the different aspects of the present invention. Thus, the steps, methods and/or functionality disclosed herein can be implemented in any combination of hardware circuitry and software.

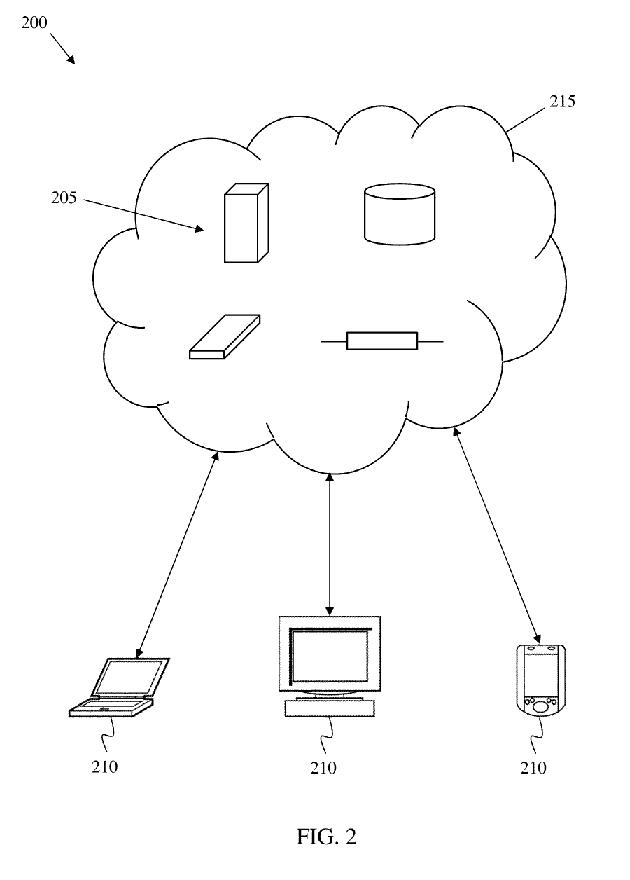

FIG. 2 shows an exemplary cloud computing environment 200. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may includes one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

One or more cloud resources 205 may be conceptually structured in multiple layers. In one example, the layers include a firmware and hardware layer, a kernel layer, an infrastructure service layer, a platform service layer, and an application service layer. The firmware and hardware layer may be the lowest layer upon which the other layers are built, and may include generic contributing nodes (e.g., data centers, computers, and storage devices) geographically distributed across the Internet and provide the physical resources for implementing the upper layers of the cloud service provider. The kernel layer is above the firmware and hardware layer and may include an operating system and/or virtual machine manager that host the cloud infrastructure services. The kernel layer controls and communicates with the underlying firmware and hardware layer through one or more hardware/firmware-level application programming interfaces (APIs). The infrastructure service layer is above the kernel layer and may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer is above the infrastructure service layer and may include platforms and application frameworks that provide platform services, such as an environment for running virtual machines or a framework for developing and launching a particular type of software application. The application service layer is above the platform service layer and may include a software application installed on one or more virtual machines or deployed in an application framework in the platform service layer. The software application can also communicate with one or more infrastructure service components (e.g., firewalls, databases, web servers, etc.) in the infrastructure service layer.

In another example, one or more cloud resources 205 may be conceptually structured in functional abstraction layers including a hardware and software layer, a virtualization layer, a management layer, and a workloads layer. The hardware and software layer may include hardware and software components such as mainframes, RISC (reduced instruction set computer) architecture based servers, storage devices, networks and networking components, application server software, and database software. The virtualization layer may include virtual entities such as virtual servers, virtual storage, virtual networks, virtual applications, and virtual clients. The management layer may provide functions such as resource provisioning, metering and pricing, security, user portals, service level management, and service level agreement planning and fulfillment. The workloads layer may provide functions for which the cloud computing environment is utilized, such as mapping and navigation, software development and lifecycle management, data analytics and processing, and transaction processing.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

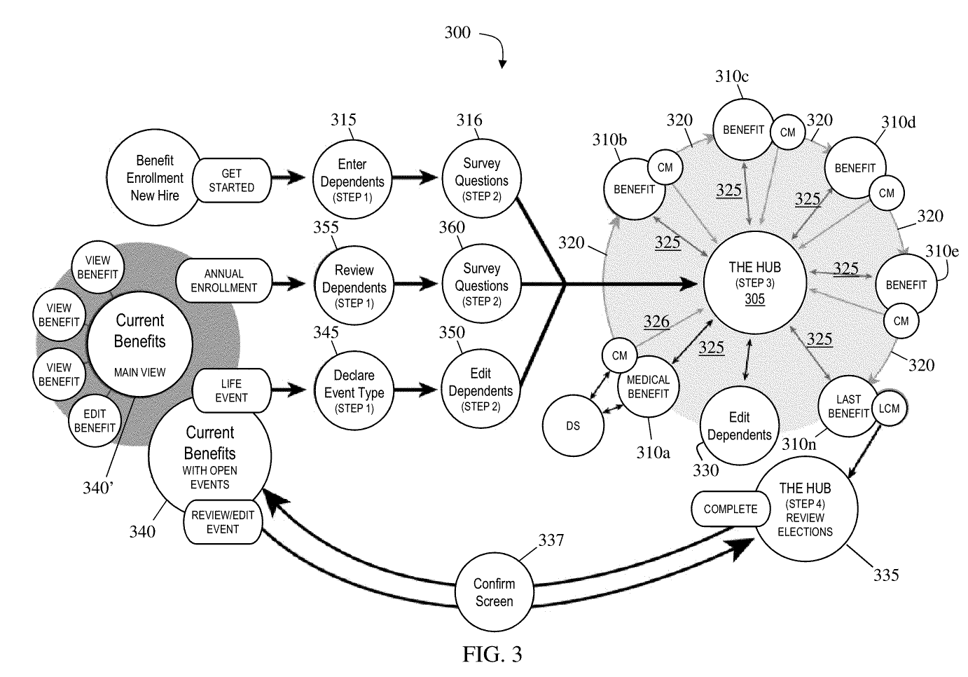

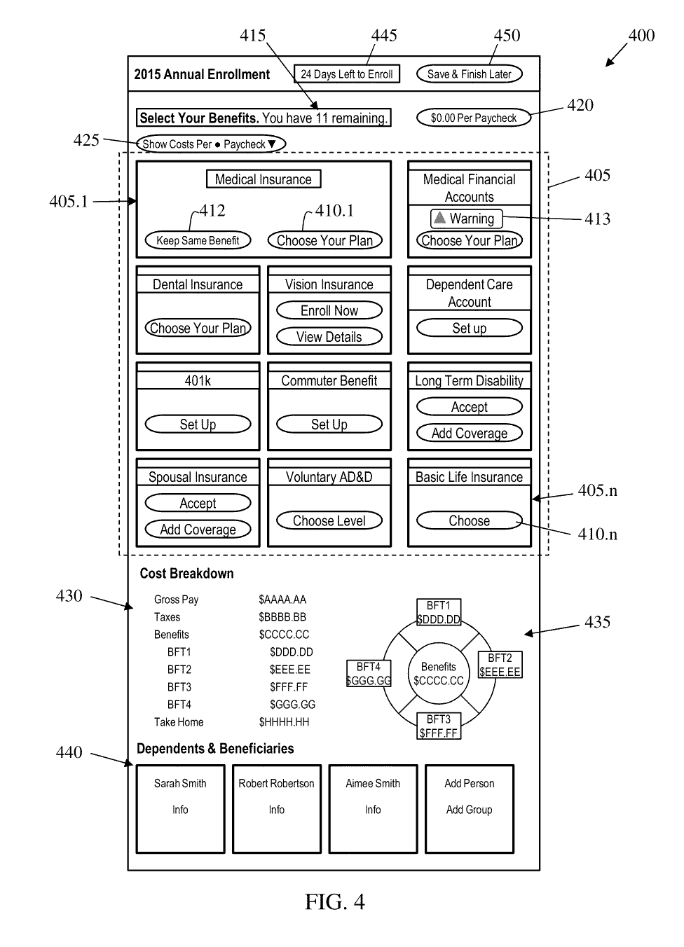

FIG. 3 shows a block diagram in accordance with aspects of the invention. More specifically, FIG. 3 shows a functional block diagram 300 that illustrates processes and/or functionality of aspects of the invention. Each block (e.g., circle, oval, etc.) in the block diagram 300 may correspond to one or more modules and/or screens of a user interface (UI) that is presented to a user via a user computer device (e.g., client device 210). Examples of such modules and/or screens of the user interface are described in greater detail herein with respect to FIGS. 4-14. Data that defines each screen of the user interface may be generated and/or provided to the user computer device at least in part by a back-end system, such as computing system 100 of FIG. 1. The data may be obtained by the back-end system from disparate sources, such as for example a human resources database and a payroll database.

As shown in FIG. 3, block 305 represents a hub UI through which a user may view available benefits, elect certain ones (or aspects) of the available benefits, and edit their elections. An exemplary hub UI represented by block 305 is shown in FIG. 4 and is described in greater detail below.

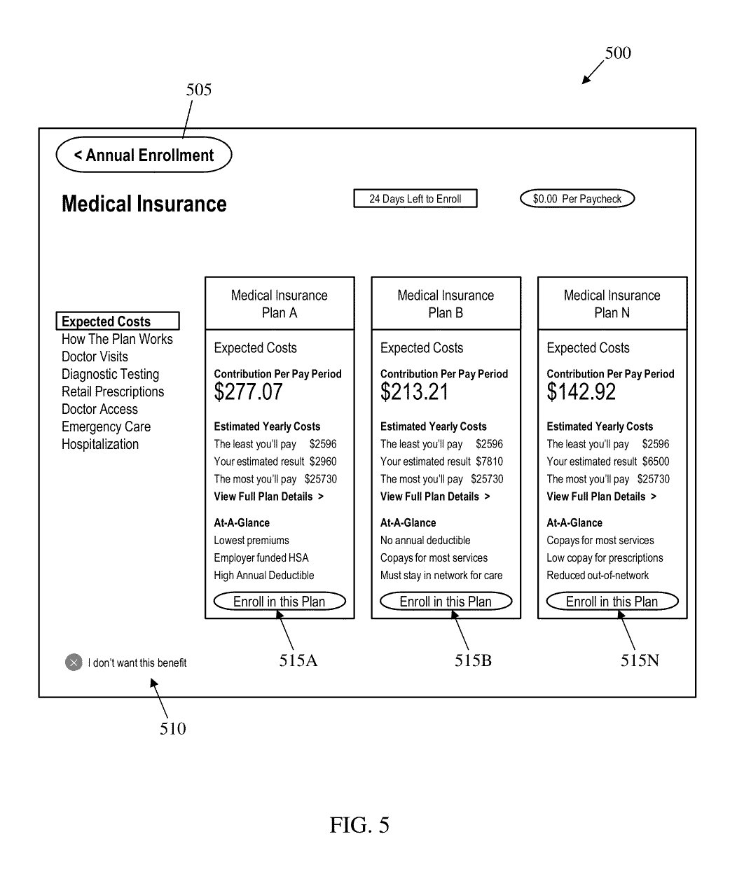

Still referring to FIG. 3, blocks 310a-n represent benefit election UI's that correspond to particular ones of the available benefits. For example, block 310a may correspond to a medical insurance benefit UI at which the user may view information about options for this benefit and make one or more elections associated with of one of the options. An exemplary medical benefit UI represented by block 310a is shown in FIG. 5 and is described in greater detail below.

In embodiments, the number of blocks 310a-n and the content of each of the benefit UIs associated with the blocks 310a-n is defined based on the employer's available benefits and options within each benefit (e.g., a predefined set of available elections corresponding to employee benefits), and also on data entered by the employee at one or more of blocks 315, 316, 345, 350, 355, and 360 that correspond to UIs where the user enters basic and dependent information (e.g., name, age, marital status, dependents, etc.). As indicated by arrows 320, the system has a default state that is configured to prompt the user through blocks 310a-n in a predefined order; however, the user is not constrained to navigate the blocks 310a-n in any particular order. Instead, as indicated by arrows 325, the user may navigate back and forth from the hub UI block 305 to any UI of blocks 310a-n in any order desired by the user. In this manner, the user is not constrained to linearly step through the UIs in a predefined order, such that the user may navigate non-linearly through a number of benefit selection UIs.

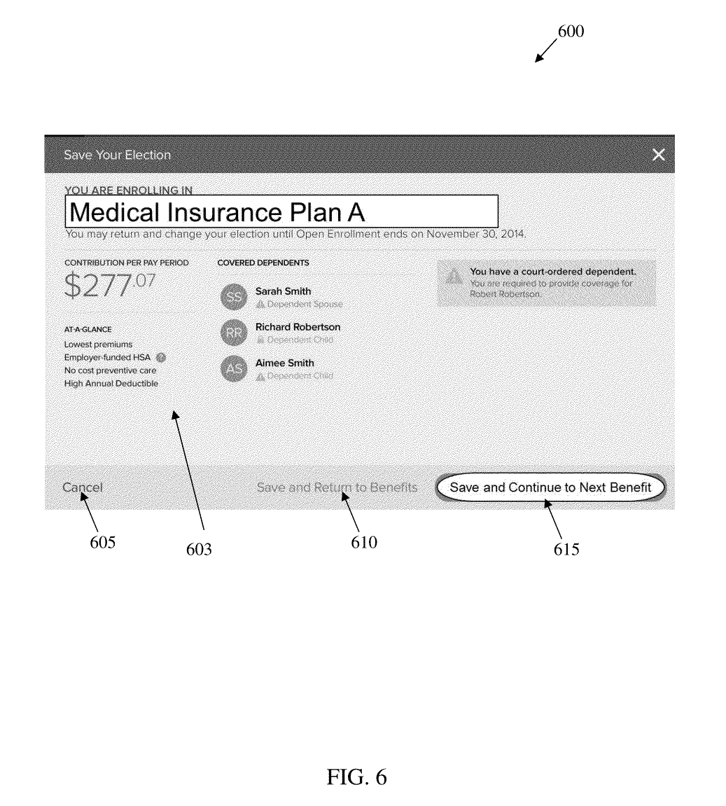

Each block 310a-n may have an associated “CM” block that represents a confirmation screen that is presented to the user when the user makes an election of a particular benefit. For example, after the user makes an election of a medical insurance plan in the UI associated with block 310a, a confirmation screen may be displayed informing the user that they made the election and asking them to confirm the election with an action such as clicking on a selectable object. In embodiments, the confirmation screen includes a first user-selectable confirmation object that when selected by the user navigates the user back to the hub UI as indicated by arrow 326, and a second user-selectable confirmation object that when selected by the user navigates the user back to the a next benefit UI indicated by arrow 320. An exemplary confirmation screen represented by block CM is shown in FIG. 6 and is described in greater detail below.

Further, one or more blocks 310a-n may have an associated “DS” block that represents decision support information that is displayed to the user at the interface. The decision support information may include additional information and tools associated with the benefit being elected. For example, for the medical benefit UI of block 310a may have additional screens (represented by block DS) that are displayed to the user and include cost estimators for the available plans, comparison charts for the available plans, etc.

As additionally shown in FIG. 3, in embodiments the system is configured to permit a user to navigate to an edit dependents UI represented by block 330 directly from the hub UI at block 305. The edit dependents UI represented by block 330 may permit the user to edit the information regarding dependents that was previously entered at block 315 and/or 350 without having to back out of the hub UI to travel back to block 315 or 350. Alternatively, the hub UI may permit the user to edit their dependent information directly in the hub UI without navigating to a separate edit dependents UI.

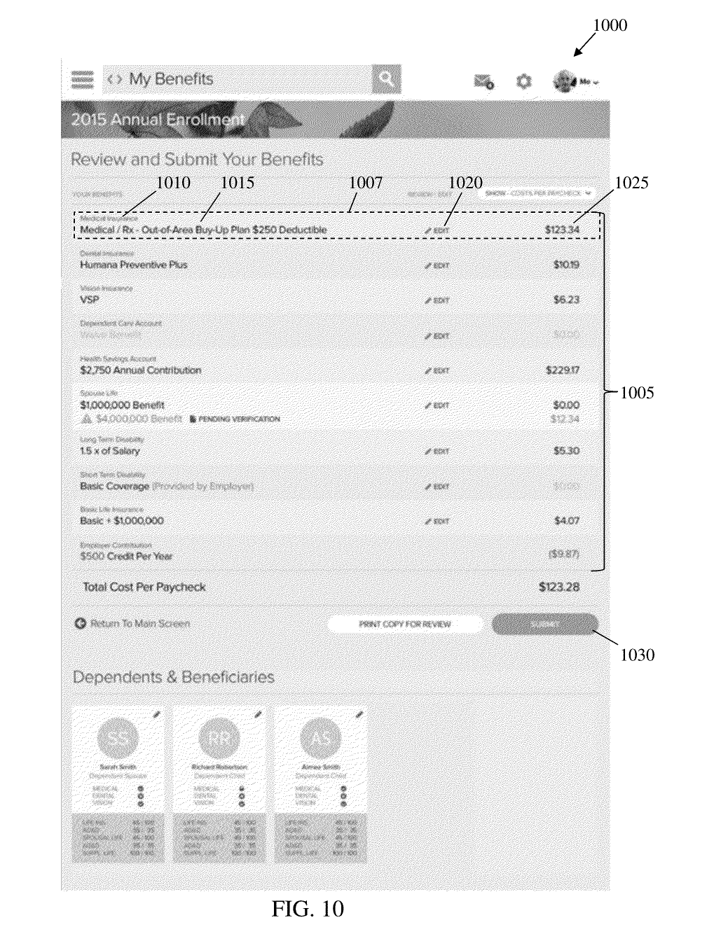

Block 335 of FIG. 3 represents a “review elections” UI, which allows the user to review in a single screen all the elections that were made at blocks 310a-n. In embodiments, the review UI at block 335 is a modified version of the hub UI and is generated once the user has made an election in each of the available blocks 310a-n (e.g., completed all available elections). The review UI at block 335 may include selectable objects (e.g., buttons or hyperlinks) that permit the user to navigate directly back to the benefit UI at a respective one of blocks 310a-n to edit any of the already-elected benefits. The review UI at block 335 may also include a selectable object that the user may select to complete their enrollment in the elected benefits. An exemplary review UI represented by block 335 is shown in FIG. 10 and is described in greater detail below.

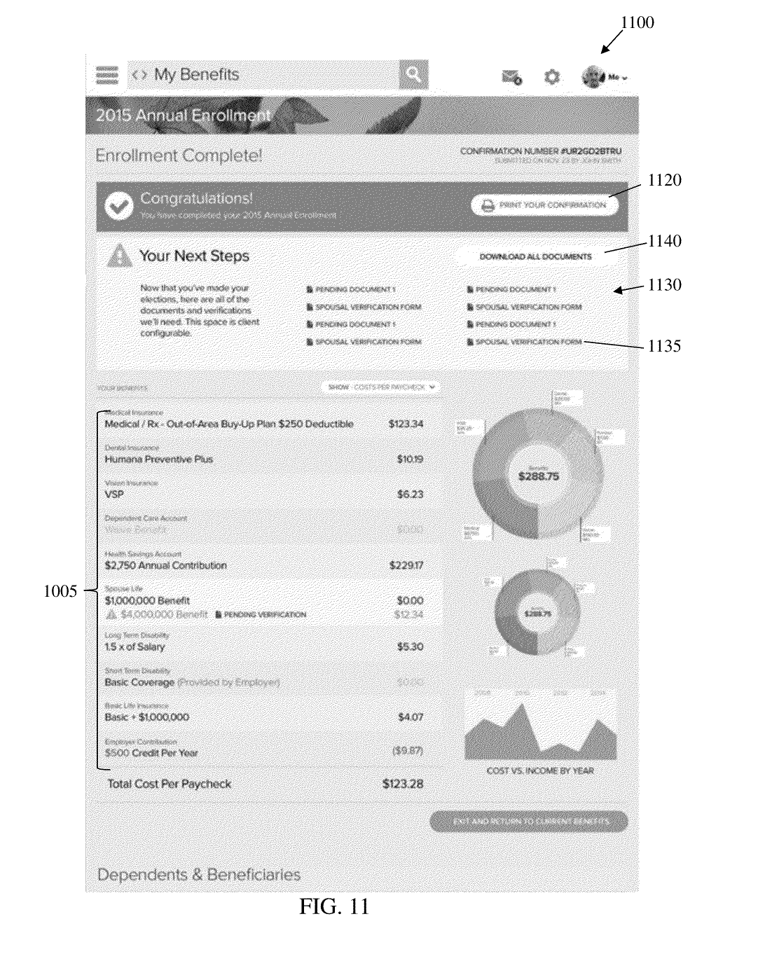

With continued reference to FIG. 3, when the user provides input to complete their enrollment at the review UI generated at block 335, as indicated by the “COMPLETE” block, the process proceeds to a confirmation UI represented by block 337. In embodiments, the confirmation UI associated with block 337 displays all the elections that were made at blocks 310a-n but without any links for editing the elections. The confirmation UI includes a selectable object that the user may select to complete their election. An exemplary confirmation UI represented by block 337 is shown in FIG. 11 and is described in greater detail below.

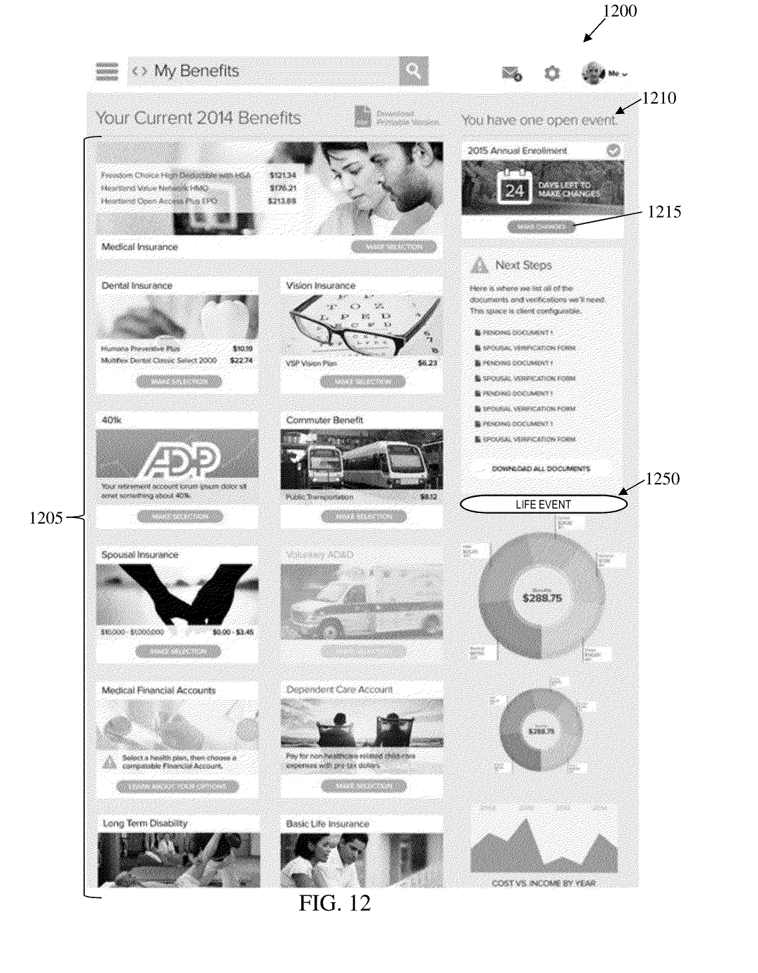

After the user completes their election at block 337, the process proceeds to block 340 which represents a “current benefits with open events” UI that displays the benefits that the user has in place for the current time period, in contrast to the elections that the user makes at blocks 310a-n for benefits for a future time period. For example, current benefits at block 340 may refer to benefits that the user has previously elected for the current year (e.g., 2014), whereas the elections made via blocks 310a-n are for the upcoming year (e.g., 2015). According to aspects of the invention, the UI generated at block 340 shows the user any open events, such as annual enrollment, life events, etc. When there are no open events, a “current benefits main view” UI at block 340′ is presented. The current benefits main view UI represented by block 340′ permits the user to view their current benefits, and permits the user to edit any current benefits that may be edited outside of a life event or annual enrollment. For example, in some instances, a user may be permitted to edit their 401k contribution amount and/or health savings account amount any time during the year independent of a life event or annual enrollment. In embodiments, the current benefits main view UI represented by block 340′ may include a selectable object that the user may select to make such a change. An exemplary current benefits UI represented by block 340 is shown in FIG. 12 and is described in greater detail below.

Still referring to FIG. 3, the interfaces generated at blocks 340 and 340′ may permit a user to declare a life event, which causes the system to proceed to interfaces represented by blocks 345 and 350. At blocks 345 and 350, the system prompts the user to enter information about the life event, such as declaring the event type and editing dependent information. Further, during an annual enrollment open season as defined by the employer, the interfaces generated at blocks 340 and 340′ may permit a user to navigate to interfaces represented by blocks 355 and 360. At blocks 355 and 360, the system prompts the user to review their dependent information and enter basic information via survey questions. Following blocks 345 and 350 (or blocks 355 and 360), the process returns to block 305 where the user is presented with available benefits that are determined based in part on the user input received at blocks one or more of blocks 345, 350, 355, 360 and that are electable in the manner as already described herein.

FIG. 4 shows an exemplary hub UI 400 that is associated with block 305 of FIG. 3. In embodiments, the hub UI 400 displays all the available benefits for the user and provides links for the user to access respective UIs associated with blocks 310a-n of FIG. 3, for the purpose of completing the benefit election process.

In accordance with aspects of the invention, the hub UI 400 is reconfigurable and dynamic determining, by a computer system, a one or more benefits based on a combination of user input and a predefined set of benefits

According to aspects of the invention, the hub UI 400 includes a listing 405 of benefits that are available to the user. The listing 405 includes respective tiles (e.g., areas) 405.1, . . . , 405.n associated with the respective available benefits. The available benefits included in the listing 405 are determined based on a global set of benefits that are predefined by the benefit provider (e.g., an employer) and input from the user such as a type of event (e.g., annual enrollment, new hire, life event, etc.). For example, a new hire event (represented by the path including blocks 315 and 316 of FIG. 3) may result in a first set of benefits being made available to the user for election. An annual enrollment event (represented by the path including blocks 355 and 360 of FIG. 3) may result in a second set of benefits being made available to the user for election. And a life event (represented by the path including blocks 345 and 350 of FIG. 3) may result in a third set of benefits being made available to the user for election. The first, second, and third sets of benefits may differ from one another, although there may also be some overlap of benefits among the sets. In this manner, the hub UI 400 is reconfigurable and dynamic in that, based on input from a user, it may list different benefits from the global set of benefits.

In the example, shown in FIG. 4, the total number of benefits “n” equals eleven and there are eleven tiles 405.1-n including: Medical Insurance; Medical Financial Accounts; Dental Insurance; Vision Insurance; Dependent Care Account; 401k; Commuter Benefit; Long Term Disability; Spousal Insurance; Voluntary AD&D; and Basic Life Insurance. The invention is not limited to this number “n” and is not limited to these particular benefits; rather, any number of benefits of any desired type may be represented by the tiles 405.1-n.

In embodiments, each tile 405.1-n includes a name of the benefit (e.g., Medical Insurance, Dental Insurance, etc.) and a selectable object 410.1, . . . , 410.n linked to a benefit UI where the user may review/edit/choose/select/set up their preferences for the particular benefit, as described in greater detail herein. As used herein, the term “selectable object” refers to a button or hyperlink or similar object that is displayed in the UI, that may be selected by the user with a user input such as a mouse click or finger tap, and that when selected by the user results in a change in the UI. One or more of the tiles 405.1-n may include a “keep same benefit” selectable object 412 that a user may select to keep the same settings of the particular benefit from the previous year, which allows a user to quickly speed through their elections if they are happy with what they have in the current year. For example, if a user is satisfied with the medical insurance of their current benefits (e.g., for year 2014), the user may select the “keep same benefit” selectable object 412 to elect that same benefit for the next year (e.g., year 2015). In embodiments, the system is configured to determine whether the same benefit is available from one year to the next, and to display the “keep same benefit” selectable object 412 when the same benefit is available, and to not display the “keep same benefit” selectable object 412 when the same benefit is not available.

One or more of the tiles 405.1-n may also include a warning 413 that insufficient data is currently available for completing the election associated with the benefit. For example, as shown in FIG. 4, the Medical Financial Accounts tile includes a warning 413 that there is insufficient data to complete the selection of the Medical Financial Accounts benefit. This lack of data may be due to the user not having completed a different benefit election that is a prerequisite to this particular benefit election. For example, the system may be programmed such that the information displayed in a benefit UI associated with the Medical Financial Accounts benefit is dependent on the particular medical insurance plan that is selected in the Medical Insurance benefit, such that it is necessary for the user to complete the Medical Insurance benefit election prior to completing the Medical Financial Accounts benefit election. In embodiments, the user may still navigate to the Medical Financial Accounts benefit UI prior to completing the Medical Insurance benefit election, e.g., to review any information that is available, but the system will prevent the user from making a selection within the Medical Financial Accounts benefit UI. In embodiments, the system is configured to automatically remove the warning 413 from the hub UI 400 when the necessary data has been provided.

Still referring to FIG. 4, in embodiments the hub UI 400 includes an indication of a number of remaining benefits 415, i.e., benefits on which the user must take action to complete the benefit election process. As the user completes their election of each benefit, the system reconfigures the hub UI 400 to change the displayed number of remaining benefits 415 to keep the user apprised of the overall state of their benefit election process, as described in greater detail herein. The change may be made in real time.

In embodiments, the hub UI 400 includes a cumulative cost 420 of elected benefits, i.e., the cost to the user of the elected benefits. As the user completes their election of each benefit, the system reconfigures the hub UI 400 to change the displayed cumulative cost 420. The change may be made in real time. The hub UI 400 may include a selectable object 425 (e.g., a drop down menu) in which the user may select a time period associated with the cumulative cost 420, e.g., per paycheck, per month, per year, etc.

The hub UI 400 may also include Cost Breakdown data 430 including one or more of: gross pay, taxes (withheld), cost of each individual benefit, and take home for the user. The taxes, cost of benefits, and take home may change based on the user's election of benefits, and the hub UI 400 updates the Cost Breakdown data 430 in real time as elections are made to reflect such changes. The Cost Breakdown data 430 may also include a graphic visualization 435 (e.g., a pie chart, etc.) of the costs of the respective individual benefits. Some of the data used to generate the Cost Breakdown data 430, such as gross pay and taxes, may be obtained from a payroll database.

With continued reference to FIG. 4, the hub UI 400 may also include Dependents and Beneficiaries data 440. In embodiments, the Dependents and Beneficiaries data 440 is a consolidated display of data that was entered at block 315 and/or block 350, and may include information such as dependent name, relationship, insurance coverage, etc. The hub UI 400 may also be configured to permit the user to edit certain dependent data directly in the hub UI 400, or alternatively may have a selectable object for the user to navigate to an edit dependents UI as described with respect to block 330 of FIG. 3.

The hub UI 400 may also include an indicator 445 of time remaining for the user to complete the benefit election process. For example, during an annual enrollment, the indicator 445 may display the number of days remaining in the annual enrollment period. The hub UI 400 may also include a selectable object 450 that the user may select to save their progress in the benefit election process without having completed the entire benefit election process. For example, a user may make their respective benefit elections for less than the total number of available benefits, save their elections by selecting the selectable object 450, close the program, and then return to the program at a later time, in which case the system presents the hub UI 400 according to the user's previously saved selections.

FIGS. 5-12 show an exemplary sequence of user interfaces that illustrate processes and functionality in accordance with aspects of the invention. Specifically, FIGS. 5-12 depict an exemplary series of steps of a user electing benefits starting at the hub UI 400 of FIG. 4. The particulars of the interfaces shown in FIGS. 5-12 are exemplary and shown for the purpose of illustrating the processes and functionality, and are not intended to limit the invention.

FIG. 5 shows an exemplary medical benefit UI 500 that is associated with block 310a of FIG. 3. In embodiments, the medical benefit UI 500 is displayed as a result of the user selecting the selectable object 410.1 of the Medical Insurance tile 405.1 of the hub UI 400 of FIG. 4. In embodiments, the medical benefit UI 500 displays information regarding medical insurance plans that are available to the user for selection of this particular benefit. The information associated with each available medical insurance plan is defined by the benefit provider (e.g., an employer) and is obtained by the computer system, for example, from a human resources database. Any desired information may be displayed in the medical benefit UI 500, and the invention is not limited to the information shown in FIG. 5. Moreover, although three plans are depicted in the medical benefit UI 500, any desired number “N” of plans may be included.

In accordance with aspects of the invention, the medical benefit UI 500 includes a selectable object 505 that the user may select to return to the hub UI 400 of FIG. 4 without making an election of one of the available medical insurance plans. The medical benefit UI 500 may also include a selectable object 510 that the user may select to waive this benefit and return to the hub UI 400 of FIG. 4. The medical benefit UI 500 may also include respective selectable objects 515A, 515B, 515N associated with the displayed medical insurance plans, by which the user may select one of the plans for this benefit.

FIG. 6 shows an exemplary confirmation screen 600 that is associated with one of the CM blocks of FIG. 3. In embodiments, the confirmation screen 600 is displayed as a result of the user selecting one of the selectable object 515A-N (e.g., 515A in this example) of the medical benefit UI 500 of FIG. 5. The confirmation screen 600 may include summary information 603 about the selection the user made in the medical benefit UI 500 of FIG. 5. In this example pertaining to the medical insurance benefit, the information 603 may include but is not limited to the cost per pay period to the user, the dependents that are covered by the insurance, and other details of the selected plan. The confirmation screen 600 may be a modal screen.

In accordance with aspects of the invention, the confirmation screen 600 includes a first selectable object 605 that the user may select to cancel this election and return to the medical benefit UI 500 of FIG. 5. The confirmation screen 600 may also include a second selectable object 610 that the user may select to save (i.e., confirm) this election and return to the hub UI 400 of FIG. 4, e.g., as indicated by arrow 326 of FIG. 3. In this manner, the user may navigate back to the hub UI and then navigate to any other benefit of their choosing in any desired order. The confirmation screen 600 may also include a third selectable object 615 that the user may select to save (i.e., confirm) this election and go to the next benefit UI, e.g., as indicated by arrow 320 of FIG. 3. In this manner, the user may permit the system to navigate the user to the next benefit UI as set by a predefined sequence.

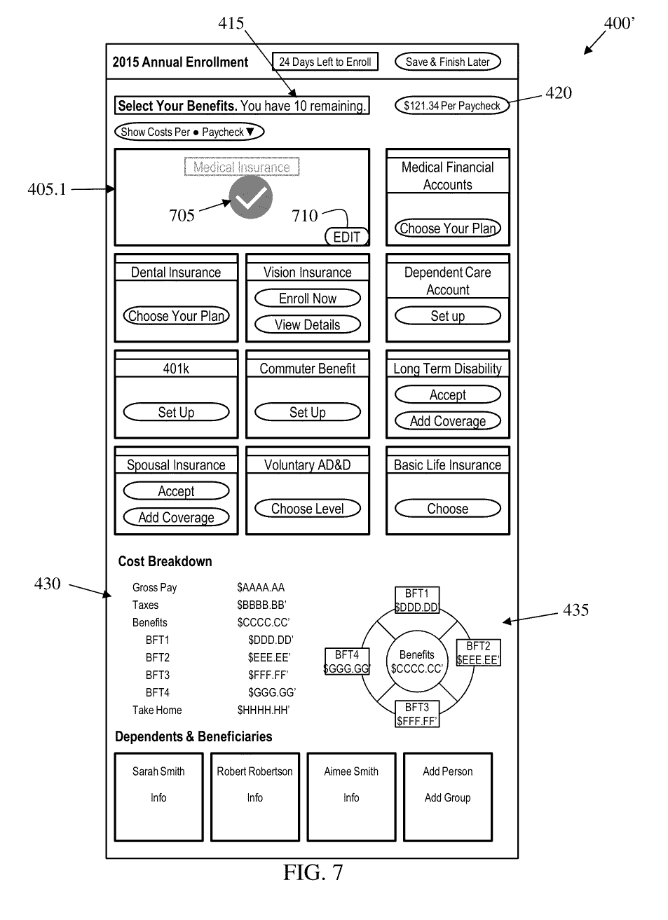

FIG. 7 shows the hub UI 400′ after the user has completed the Medical Insurance benefit election. The hub UI 400′ of FIG. 7 is displayed as a result of the user selecting the second selectable object 610 of the confirmation screen 600 of FIG. 6. As shown in FIG. 7, the hub UI 400′ is updated to reflect changes based on the election of the Medical Insurance benefit. For example, the Medical Insurance tile 405.1 of hub UI 400′ may be displayed with a different appearance from that of hub UI 400 of FIG. 4 to indicate that a selection of this benefit is complete. In this example, a check mark indicator is displayed over the tile 405.1, and the lines and/or alpha-numeric contents of the tile 405.1 are lightened relative to the previous view (FIG. 4) to indicate that this benefit is complete. The invention is not limited to these types of different appearance, and any suitable change(s) in appearance may be used. Additionally, the tile 405.1 is now provided with an EDIT selectable object 710 that, when selected by the user, navigates the user back to the associated benefit UI (medical benefit UI 500 of FIG. 5 in this example) where the user may change their election for this benefit.

Still referring to FIG. 7, certain data in the hub UI 400′ has been changed relative to the previous view of the hub UI 400 (of FIG. 4) due to the user completing a benefit selection. For example, the number 415 of remaining benefits has decremented (e.g., from eleven to ten). Also, the cost 420 has been updated to reflect the costs associated with the selected benefit (e.g., $277.07 as indicated in the confirmation screen 600 of FIG. 6). Additionally, the cost breakdown 430 and/or the visualization 435 may be changed based on the selected benefit. For example, selecting a health insurance plan that is paid for with the user's pre-tax income deducted from gross pay may affect one or more of the user's taxes (changed from $BBBB.BB to $BBBB.BB′), benefit costs (changed from $CCCC.CC to $CCCC.CC′), and take home (changed from $HHHH.HH to $HHHH.HH′). In this manner, the system provides the technological advancement of determining the user's gross pay (e.g., from a payroll database); determining the user's take home (net) pay based on taxes and the cumulative costs of all elected benefits; and determining and displaying a change to the user's take home (net) pay in real time based on the user completing an election of one of the one or more benefits.

Another change shown in hub UI 400′ is the omission of the warning 413 that was present in the Medical Financial Accounts tile of the hub UI 400 of FIG. 4, i.e., indicating that the Medical Financial Accounts now active, due to the user's completion of the Medical Insurance benefit providing the data that is a prerequisite for the Medical Financial Accounts benefit. In this manner, the system provides the technological advancement of receiving the election of one of the benefits and, based on the receiving the election, reconfiguring the hub UI to visually indicate a previously inactive one of the one of the benefits is now active. In the event the user selects the EDIT selectable object 710 and changes their election for this benefit, the system is configured to update the number 415 of remaining benefits, cost 420, and cost breakdown 430 based on the changed election.

FIGS. 5-7 as described above depict an example in which the user completes the Medical Insurance benefit first before any of the other benefits. It is noted, however, that the user may choose to complete another benefit first, e.g., prior to completing the Medical Insurance benefit (other than the Medical Financial Accounts benefit). Indeed, as described herein, the hub UI 400 permits the user to review and elect the benefits in any desired order (other than prerequisite situations, such as described with respect to the Medical Financial Accounts benefit).

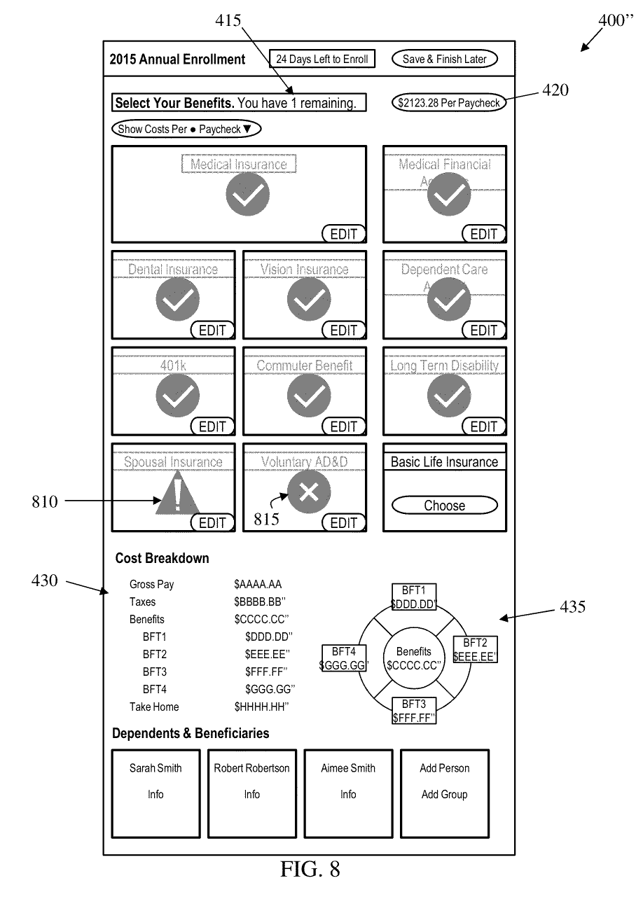

FIG. 8 shows the hub UI 400″ after the user has completed all but one of the available benefits. Similar to the hub UI 400′ of FIG. 7, the system alters the visual appearance of the tiles of the completed benefits to indicate to the user that these benefits are completed. Also similar to the description of FIG. 7, the system updates the number 415 of remaining benefits, cost 420, and cost breakdown 430 based on all the completed benefits. Each completed tile also has an EDIT selectable object (similar to EDIT selectable object 710 of FIG. 7) that permits the user to go back into the associated benefit UI and change their election for that benefit.

As additionally depicted in FIG. 8, one or more tiles may have a pending approval indicator 810 which indicates that the user's election of the particular benefit is complete but waiting approval (e.g., from an employer, insurance provider, etc.). Further, one or more tiles may have a waiver indicator 815 which indicates that the user has voluntarily selected to waive the particular benefit. The indicators 810 and 815 may have any desired form.

Still referring to FIG. 8, in accordance with aspects of the invention, the system is configured to determine when there is one last benefit remaining, i.e., when all but one benefit has been completed as shown in hub UI 400″. When it is the case that there is only one benefit remaining, the user may navigate to the benefit UI of the last benefit in the same manner as already described herein. Upon completing their selection at the benefit UI of the last benefit, the system displays a last confirmation screen represented by block LCM of FIG. 3.

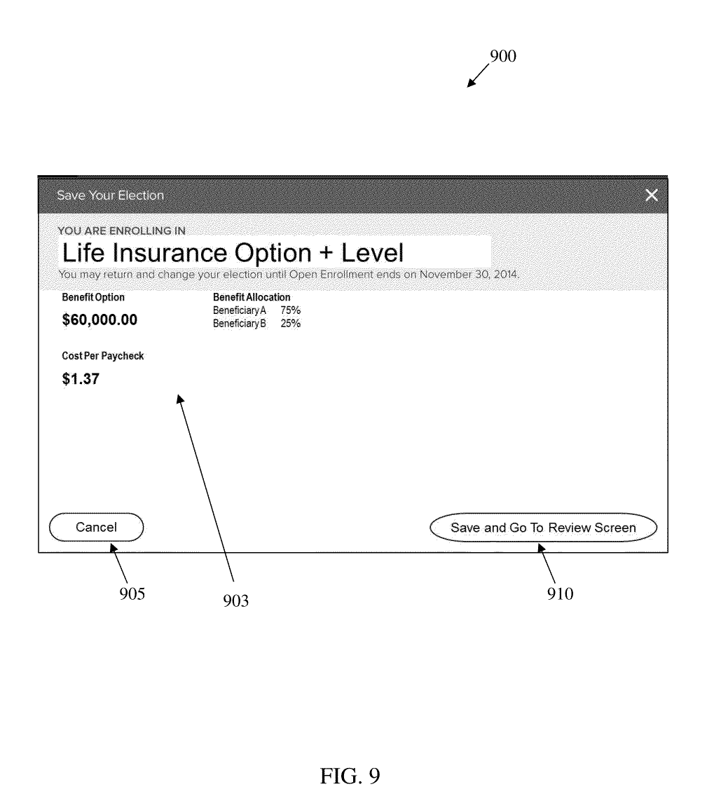

FIG. 9 shows an exemplary last confirmation screen 900 that is associated with the LCM block of FIG. 3. In embodiments, the last confirmation screen 900 is displayed as a result of the user selecting a particular selectable object of the last benefit UI. The last confirmation screen 900 may include summary information 903 about the selection the user made in the last benefit UI. The last confirmation screen 900 includes a first selectable object 905 that the user may select to cancel the selection and return to the last benefit UI. The last confirmation screen 900 may also include a second selectable object 910 that the user may select to save (i.e., confirm) the selection for this benefit and navigate to a review UI that corresponds to block 335 of FIG. 3. The last confirmation screen 900 may be a modal screen.

FIG. 10 shows an exemplary review UI 1000 that is associated with block 335 of FIG. 3. In embodiments, the review UI 1000 is displayed as a result of the user selecting the second selectable object 910 of the last confirmation screen 900 as described with respect to FIG. 9. In embodiments, the review UI 1000 displays a listing 1005 of each of the benefits associated with tiles 405.1-n of the hub UI 400 of FIG. 4. In embodiments, the listing includes a line item 1007 for each respective benefit. The line item 1007 for a particular benefit may include, for example, the benefit type descriptor 1010 (e.g., Medical Insurance), a brief description of the user's selection 1015 (e.g., based on the user's inputs associated with elections of each of the benefits), a selectable object 1020, and a cost 1025 of this benefit. In embodiments, the selectable object 1020 permits a user to navigate directly back to the benefit UI associated with the particular benefit of the line item for the purpose of reviewing and/or editing the selection of the particular benefit. For example, selecting the selectable object 1020 associated with the Medical Insurance benefit would navigate the user directly to the medical benefit UI 500 of FIG. 5.

Still referring to FIG. 10, the review UI 1000 includes a SUBMIT selectable object 1030 that the user may select to concurrently submit all the completed benefit elections performed at blocks 310a-n and shown in the review UI 1000. In embodiments, selecting the SUBMIT selectable object 1030 navigates the user to a confirmation UI such as that represented by block 337 of FIG. 3.

FIG. 11 shows an exemplary confirmation UI 1100 that is associated with block 337 of FIG. 3. In embodiments, the confirmation UI 1100 is displayed as a result of the user selecting the SUBMIT selectable object 1030 of the review UI 1000 as described with respect to FIG. 10. In embodiments, the confirmation UI 1100 includes a listing 1105 of the selected benefits that is the same as the listing 1005 with the exception that the listing 1105 does not include selectable objects 1020 for the user to navigate back to the benefit UIs.

Still referring to FIG. 11, the confirmation UI 1100 may include a selectable object 1120 that the user may select to print a confirmation of their benefit elections. The confirmation UI 1100 may also include an information section 1130 that indicates the next steps the user must take to complete their enrollment. The information section 1130 may include selectable objects 1135 that are linked to documents and/or forms that are associated with the benefits that were elected by the user in the previous steps. For example, one of the selectable objects 1135 may be linked to a spousal verification form that is required for a particular benefit, such that selecting the selectable object 1135 permits the user to open and print the spousal verification form. In embodiments, the information that is listed in the information section 1130 is determined by the system based on the benefits that were elected by the user in the previous steps. For example, the system may use predefined associations to determine documents that are associated with the user's elections benefits. The information section 1130 may include a “download all” selectable object 1140 that the user may select to download all the listed documents and/or forms, instead of individually selecting each document and/or form.

With continued reference to FIG. 11, the confirmation UI 1100 includes an EXIT selectable object 1150 that the user may select to exit the benefit selection UIs. In embodiments, selecting the EXIT selectable object 1150 navigates the user to a current benefits UI such as that represented by block 340 of FIG. 3.

FIG. 12 shows an exemplary current benefits UI 1200 that is associated with block 340 of FIG. 3. In embodiments, the current benefits UI 1200 is displayed as a result of the user selecting the EXIT selectable object 1150 of the confirmation UI 1100 as described with respect to FIG. 11. In embodiments, the current benefits UI 1200 includes a listing 1205 of the user's current benefits, i.e., those benefits that are already in place and effective at the present time.

The current benefits UI 1200 may also include an indicator 1210 of any open events. For example, the system may be configured to display an annual enrollment open event indicator 1210 only during the dates when annual enrollment is available, e.g., as defined for example by the benefit provider. At times when the annual enrollment open event indicator 1210 is displayed, the current benefits UI 1200 may also include a selectable object 1215 that the user may select to access the annual enrollment process. In embodiments, selecting the selectable object 1215 starts the annual enrollment process anew (e.g., by going to block 345 of FIG. 3) or continues the annual enrollment process where the user previously left off (e.g., by going to block 305 of FIG. 3).

The current benefits UI 1200 may also include a life event selectable object 1250 that the user may select to declare a life event. Selecting the life event selectable object 1250 navigates the user to the path defined by blocks 345 and 350 of FIG. 3.

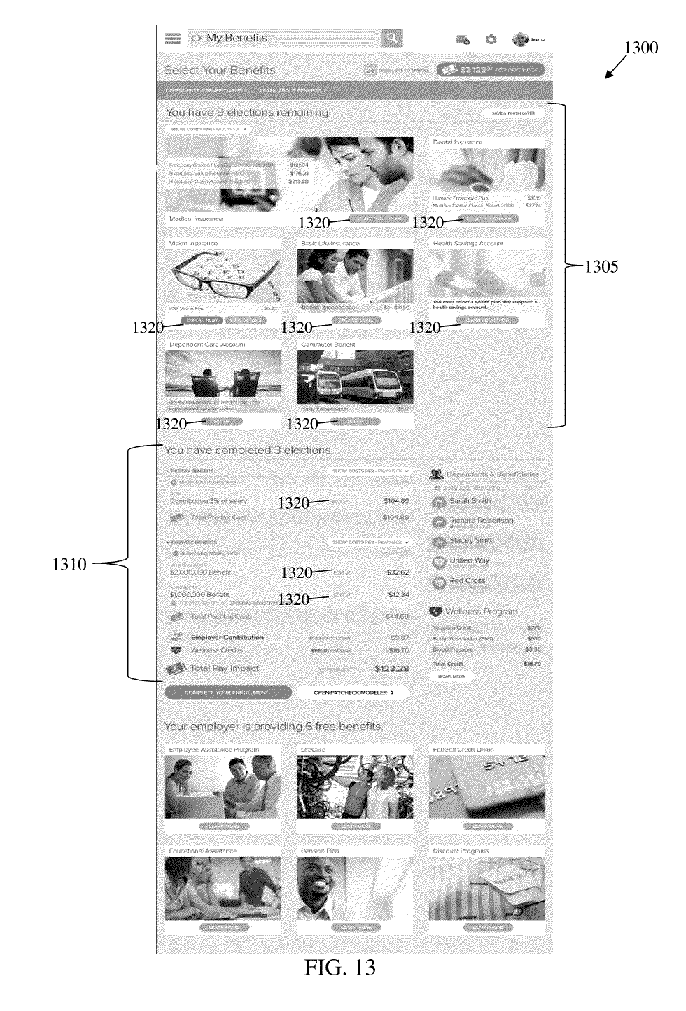

FIG. 13 shows another exemplary embodiment of a hub UI 1300 that is associated with block 305 of FIG. 3. In embodiments, the hub UI 1300 includes a first section 1305 that displays remaining elections, i.e., benefits for which the user has not yet made an election. In embodiments, the hub UI 1300 also includes a second section 1310 that displays completed elections, i.e., benefits for which the user has made an election. In embodiments, the hub UI 1300 includes a respective “edit” selectable object 1320 with each election in both the first section 1305 and the second section 1310. By selecting the edit selectable object 1320, the user may directly access the benefit UI for editing the respective election (e.g., for navigating directly to one of blocks 310a-n as shown in FIG. 3).

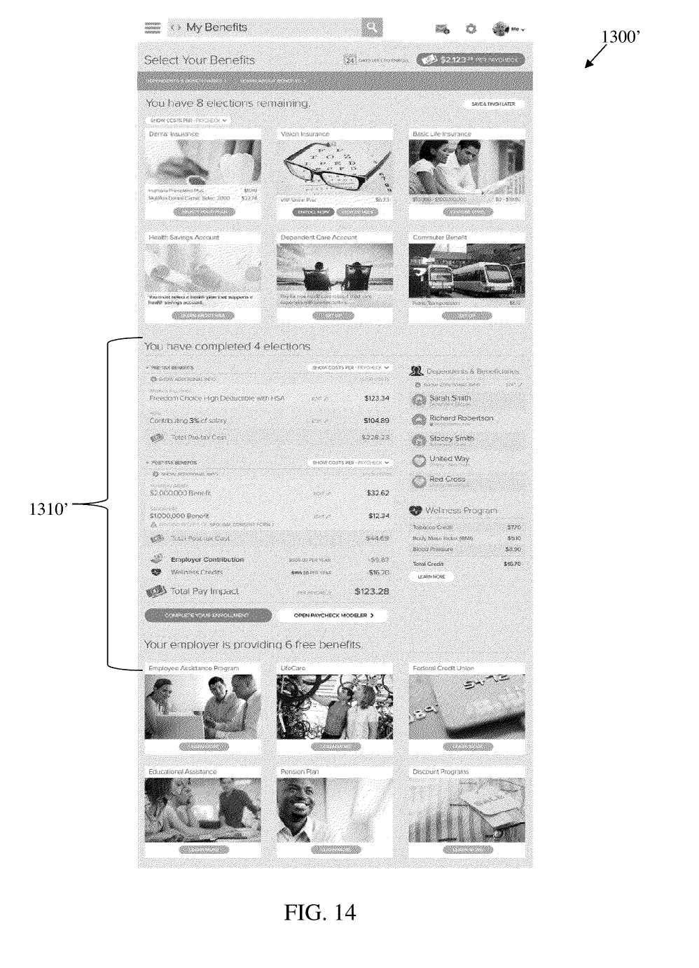

FIG. 13 shows the hub UI 1300 in an illustrative example in which the user has nine elections remaining. FIG. 14 shows the hub UI 1300′ in an illustrative example in which the user has eight elections remaining, i.e., after the user has made an election of one of the nine elections that were previously remaining in FIG. 13. In this example, between FIGS. 13 and 14 the user has made an election of medical insurance, such that the medical insurance benefit is omitted from the first section 1305 (e.g., remaining elections) in FIG. 13 and added to the second section 1310′ (e.g., completed elections) in FIG. 14. In this manner, the hub UI 1300 includes: a first section 1305 comprising data indicating remaining elections of the available elections; a second section 1310 comprising data indicating completed elections of the available elections; and respective selectable objects associated with respective ones of the available elections, wherein when a user selects one of the respective selectable objects the computer system navigates the user to a new UI configured for permitting the user to edit the respective one of the available elections associated with the selected one of the respective links. In embodiments, the data presented in the first section 1305 and the second section 1310 is updated (e.g., changed as shown in FIGS. 13 and 14) based upon receiving an input indicating an election of one of the remaining elections.

In embodiments, the various user interfaces described with respect to FIGS. 3-14 may be part of a collection of interfaces that make up an overall employee benefit UI that is generated at least in part by a service provider computing device such as computing device 100 of FIG. 1.

The foregoing examples have been provided merely for the purpose of explanation and are in no way to be construed as limiting of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although aspects of the present invention have been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of generating an employee benefit user interface (UI), comprising:
determining, by a computer system, one or more benefits based on a combination of user input and a predefined set of benefits;
generating, by the computer system, a reconfigurable, dynamic hub UI that includes a listing of the one or more benefits, wherein each of the one or more benefits in the listing includes a respective selectable object; and
navigating to a benefit UI associated with a particular one of the one or more benefits based on receiving a selection of the selectable object associated with the particular one of the benefits.

2. The method of claim 1, further comprising:
receiving an election of the particular one of the benefits at the benefit UI; and
based on the receiving the election, navigating to a confirmation screen that includes:
a first selectable object that when selected by the user navigates back to the benefit UI;
a second selectable object that when selected by the user navigates to the hub UI; and
a third selectable object that navigates to a next benefit UI associated with a next one of the one or more benefits.

3. The method of claim 1, further comprising:
receiving an election of the particular one of the benefits at the benefit UI; and
based on the receiving the election, reconfiguring the hub UI to visually indicate the election of the particular one of the benefits.

4. The method of claim 3, wherein the reconfiguring the hub UI to visually indicate the election of the particular one of the benefits includes one of:
changing a visual appearance of the particular one of the benefits in the listing; and
removing the particular one of the benefits from the listing.

5. The method of claim 1, further comprising:
receiving an election of the particular one of the benefits at the benefit UI; and
based on the receiving the election, reconfiguring the hub UI to visually indicate a previously inactive one of the one of the benefits is now active.

6. The method of claim 1, further comprising:
determining a number of remaining benefits;
causing the hub UI to display the number of remaining benefits; and
changing the displayed number of remaining benefits in real time based on the user completing an election of one of the one or more benefits.

7. The method of claim 1, further comprising:
determining the user's gross pay;
determining the user's net pay;
determining and displaying a change to the user's net pay in real time based on the user completing an election of one of the one or more benefits.

8. The method of claim 7, further comprising:
determining a cumulative cost of completed benefits;
causing the hub UI to display the cumulative cost; and
changing the displayed cumulative cost in real time based on the user completing an election of one of the one or more benefits.

9. The method of claim 1, wherein the hub UI is configured to permit the user to navigate non-linearly to any one of a plurality of benefit UIs associated with the one or more benefits, respectively.

10. The method of claim 1, further comprising:
generating a current benefits UI that includes a life event selectable object;
based on receiving a selection of the life event selectable object, prompting the user to input information about the life event; and
navigating to the hub UI after receiving the information about the life event.

11. The method of claim 1, further comprising:
generating a current benefits UI that includes an open event selectable object, wherein the open event selectable object is only displayed during dates associated the open event; and
navigating to the hub UI based on receiving a selection of the open event selectable object.

12. The method of claim 11, further comprising:
determining a time period remaining in the open event; and
causing the current benefits UI to display the determined time period remaining in the open event.

13. The method of claim 1, wherein the predefined set of benefits includes: medical insurance, vision insurance, dental insurance, life insurance, accidental death and dismemberment insurance, disability insurance, spousal insurance, dependent care, commuter benefit, educational assistance, retirement benefits.

14. The method of claim 1, further comprising:
generating a review UI using information defined by user inputs associated with elections of each of the one or more benefits; and
navigating to the review UI based on completing the elections of all of the one or more benefits.

15. The method of claim 14, further comprising:
determining documents associated with the elections of the one or more benefits;
generating a confirmation UI including links to the documents; and
navigating to the confirmation UI from the review UI.

16. A computer system for generating an employee benefit user interface (UI), comprising:
a hardware memory device that stores program instructions; and
a hardware processor that executes the program instructions and causes the computer system to:
generate a hub UI that includes a listing of one or more benefits based on a combination of user input and a predefined set of benefits;
navigate to a benefit UI associated with a particular one of the one or more benefits based on receiving a selection of the particular one of the benefits at the hub UI;
receive an election of the particular one of the benefits at the benefit UI; and
based on the receiving the election, reconfigure the hub UI to visually indicate the election of the particular one of the benefits.

17. The computer system of claim 16, wherein the reconfiguring the hub UI to visually indicate the election of the particular one of the benefits includes one of:
changing a visual appearance of the particular one of the benefits in the listing; and
removing the particular one of the benefits from the listing.

18. The computer system of claim 16, wherein the hub UI is configured to permit the user to navigate non-linearly to any one of a plurality of benefit UIs associated with the one or more benefits, respectively.

19. A computer program product comprising computer readable program instructions stored on computer readable storage medium, the computer readable program instructions causing a computing device to:
generate a hub UI that includes a listing of one or more benefits based on a combination of user input and a predefined set of benefits;
navigate to a benefit UI associated with a particular one of the one or more benefits based on receiving a selection of the particular one of the benefits at the hub UI;
receive an election of the particular one of the benefits at the benefit UI;
based on the receiving the election, reconfigure the hub UI to visually indicate the election of the particular one of the benefits;
generate a review UI using information defined by user inputs associated with elections of each of the one or more benefits; and
navigate to the review UI based on completing the elections of each of the one or more benefits.

20. The computer program product of claim 19, wherein the reconfiguring the hub UI to visually indicate the election of the particular one of the benefits includes one of:
changing a visual appearance of the particular one of the benefits in the listing; and
removing the particular one of the benefits from the listing.
